(19) United States
(12) Patent Application Publication
(10) Pub. No.: US 2009/0289437 A1
(43) Pub. Date: Nov. 26, 2009

(54) VEHICLE WITH THREE WHEELS

(76) Inventor: Hektor STEINHILBER, Berlin (DE)

Correspondence Address: SIMPSON & SIMPSON, PLLC, 5555 MAIN STREET, WILLIAMSVILLE, NY, 14221-5406, US

(21) Appl. No.: 12/431,531

(22) Filed: Apr. 28, 2009

Related U.S. Application Data
(63) Continuation of application No. PCT/DE2007/001988, filed on Oct. 29, 2007.

(30) Foreign Application Priority Data
Oct. 30, 2006 (DE) 10 2006 052 041.6
Apr. 18, 2007 (DE) 10 2007 019 026.5

(51) Int. Cl. B62K 5/02

(52) U.S. Cl. 280/282

(57) ABSTRACT

The frame of the vehicle, which is capable of inclining in curves and preferably comprises a front wheel and two rear wheels, is rotatably mounted to a steering head beneath the driver's seat. Rigid driving elements are arranged in the area of this steering head, which couple the inclination of the vehicle frame to the opposite movements of the rear wheel swing arms by means of control elements in order to control the vehicle inclination and steer the rear wheels. In order to support the initial horizontal position of the tricycle, return springs are provided at the steering head, which force the rear wheel swing arms into a balanced mid-position. In slow vehicles suitable for rehabilitation purposes, the steering head beneath the driver's seat may be blocked by a brake in the starting phase. In faster vehicles, the movement of the rear wheel swing arms may be assisted by foot levers or manually operated hydraulic cylinders.

### CROSS REFERENCE TO RELATED APPLICATIONS

This patent application is a continued patent application of International Patent Application No. PCT/DE2007/001988, filed on Oct. 29, 2007, which application claims priority from German Patent Application No. DE 10 2006 052 041.6, filed on Oct. 30, 2006, which applications are incorporated herein by reference in their entireties. International Patent Application No. PCT/DE2007/001988 also claims priority to German Patent Application No. DE 10 2007 019 026.5, filed on Apr. 18, 2007 which application is incorporated herein by reference in its entirety.

### FIELD OF THE INVENTION

The invention relates to a vehicle with three wheels.

### BACKGROUND OF THE INVENTION

U.S. Pat. No. 3,237,961 discloses a tricycle whose rear wheel swing arms, which are capable of moving in opposite directions, may be controlled by the driver, because their movement is coupled to the rotary movement of the handlebars by two control rods. However, the vehicle is designed as a tricycle for children. If a curve was taken at a high velocity, large forces would occur at the outer wheel, which would have to be compensated by the driver at the handlebars. For the driver to be able to exert corresponding leverage, the handlebar would have to be extremely wide or connected to a hydraulic steering assistance.

U.S. Pat. No. 4,887,829 discloses a tricycle whose rear wheels are also coupled to rear wheel swing arms movable in opposite directions. The tricycle enters the curve like a single-track vehicle following a steering impulse at the handlebars. A rocker mounted to the vehicle frame and acting as balancing element allows the opposite movements of the rear wheel swing arms. In relation to the vehicle frame, the rear wheel swing arms are freely movable and tend to distribute the load equally among the two rear wheels, as if the vehicle did not have two wheels, but only a single, very broad rear wheel. Therefore, the driver can only oppose the centrifugal forces occurring in curves at increasing speed by leaning into the curve like on a single-track vehicle until reaching the inclination limit. If the driver leans abruptly into a tight curve, the balancing element, as it is freely movable, will immediately tilt towards the outer side of the curve, which causes the inner wheel to be lifted off the road even before the inclination limit is reached. If a mechanical stop limits the operation of the balancing element, a similarly unstable driving state occurs when the outer wheel looses ground contact while the vehicle is inclined even further with the help of the inner wheel. The increase in velocity in curves, which is per se desired and results from shifting the resultant of weight and centrifugal force toward the contact point of the outer wheel, is only practicable with acrobatic skills, because the rear wheel swing arms cannot be controlled. Steering by shifting the body weight without a steering impulse is not possible either, because there is no co-steering of the rear wheels.

German translation of EP-Patent (DE 694 02 087 T2) discloses a fast tricycle whose rear wheel swing arms movable in opposite directions are connected to a rocker mounted to the vehicle frame by means of control rods, similar to the above-mentioned patent document. The rocker also acts as a freely oscillating balancing element so that the rear wheels orient themselves freely relative to the road irrespective of the inclination of the vehicle frame. Deliberate control of the swing arm movement is thus not possible. The driving experience therefore corresponds to that of an “overbalancing-prone” single-track vehicle.

German Patent Application DE 44 23 859 A1 describes various balancing elements with the help of which the rear wheels also orient themselves freely relative to the road irrespective of the inclination of the vehicle frame. Deliberate control of the swing arm movement is again impossible.

In addition, WO 86/02897 discloses a tricycle wherein the driver's seat and the front wheel fork are rigidly connected to each other. Steering is partially done by shifting the body weight, because the steering head is arranged beneath the driver's seat. The driver maintains the horizontal position of the vehicle by placing the hands on two lateral handholds. However, the steering axle is freely movable relative to the rear wheels so that the inner wheel tends to loose contact with the road if a curve is taken at a high velocity. In order to prevent the vehicle from constantly tilting over towards the outer edge of the curve, the driver's seat is arranged at an extremely low level. The use on public roads is quite limited because of the restricted field of vision and the insecure driving experience.

WO 2006/008569 A1 describes a similar recumbent tricycle wherein the initial neutral position is not only maintained by means of handholds, but also by assisting torsion springs at the steering head. Otherwise, the vehicle has the same shortcomings as the above-mentioned invention and its use in general road traffic is limited.

WO 2006/008569 A1 describes a recumbent tricycle wherein the initial neutral position of the vehicle is maintained not only by means of handholds or steering handles, but also by assisting torsion springs at the steering head. However, the vehicle is only of limited use in general road traffic because of the limited field of vision and the limited steerability.

In addition, various computerized hydraulic inclination systems for tricycles are known in prior art. Vehicles with the corresponding equipment allow shifting the resultant of weight and centrifugal force toward the contact point of the outer wheel until the vehicle drifts in an inclined position or tilts over outwards. However, due to their complexity, these systems are not suitable for light-weight, inexpensive vehicles driven by muscle force or electric motors.

### SUMMARY OF THE INVENTION

It is therefore the object of the new invention to design a light-weight tricycle having a seat position allowing a clear view, an energy-saving propulsion system and a controllable inclination mechanism, and which also allows increasing the velocity in curves in an inclined position by shifting the body weight.

It is supposed to be usable as a utility and sports vehicle and should automatically assume a neutral, horizontal basic position when standing or driving straight.

According to the invention, this object is achieved by a three-wheeled vehicle which has a steering head arranged with rigid driving elements on the vehicle frame in the area of the driver's seat.

The three-wheeled vehicle comprising: a vehicle frame; a driver's seat and two rear wheel swing arms movable in opposite directions; a steering head having rigid driving elements is arranged on the vehicle frame in the area of the driver's seat; and control elements to control the vehicle inclination and steer the rear wheels, wherein the steering head couples the inclination of the vehicle frame to the opposite movements of the rear wheel swing arms by means of the control elements.

The arrangement of the rotation axis of the rear wheel swing arms between the receptacles of the control rods and the rear wheel mounts controls the lateral downward inclination of the vehicle frame results in an upward movement of the inner rear wheel. Additionally, the rear wheel swing arms are controlled by the rotation axis of the rear wheel swing arms beyond the receptacles of the control rods by a foot lever to receive footrests which may assist in the control of the upward and downward movements of the rear wheel swing arms. The arrangement of an idler pulley on the vehicle frame in the area behind the vertical steering axis of the steerable front wheel carrier and the idler pulley redirecting the chain drive of a manually driven front wheel backwards relative to the direction of travel obtain a low position of the pedal crank bearing.

The footboards are equipped with return springs which are arranged on the rear wheel swing arms. The footboards drive the rear wheels by means of chain hoists and spiral-shaped chain wheels.

Return springs are arranged at the steering head beneath the driver's seat. The return springs stabilize the horizontal position of the vehicle by forcing the rear wheel swing arms into a balanced mid-position. A central strut is articulated between the steering head and arranged beneath the driver's seat and the vehicle frame.

At least one hydraulic cylinder is provided at the steering head and arranged beneath the driver's seat. The hydraulic cylinder allows additional control of the opposite movements of the rear wheel swing arms. A brake is provided at the steering head beneath the driver's seat, with which its rotary movement may be blocked.

The receiving bores are provided on the rear wheel swing arms movable in opposite directions and on the front wheel carrier, where snow tracks or skids may be mounted. A roof-like weather protection element is arranged on the vehicle frame.

### BRIEF DESCRIPTION OF THE DRAWINGS

Details of the invention will be explained in the following description of the preferred embodiments with reference to the drawings, in which:

FIG. 1 shows a side view of a tricycle having a manual front wheel drive;

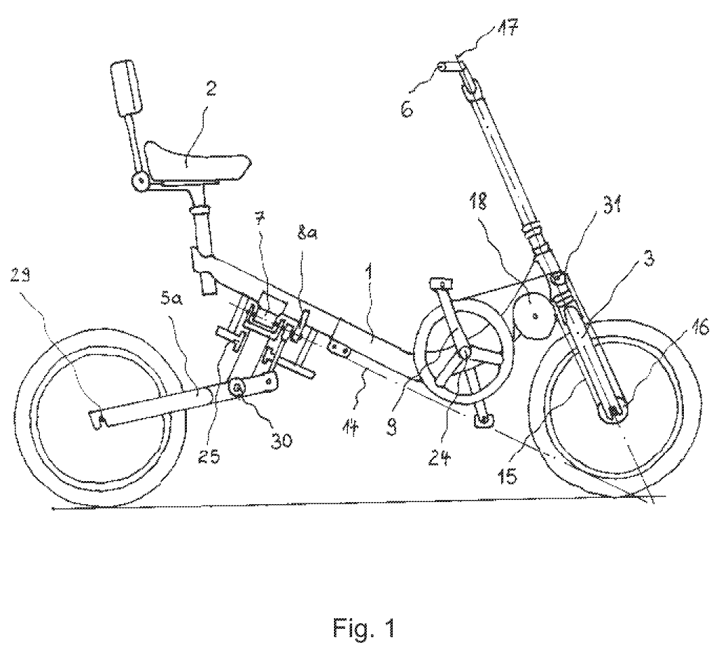

FIG. 2 shows a top view of the rear wheel swing arms of a tricycle;

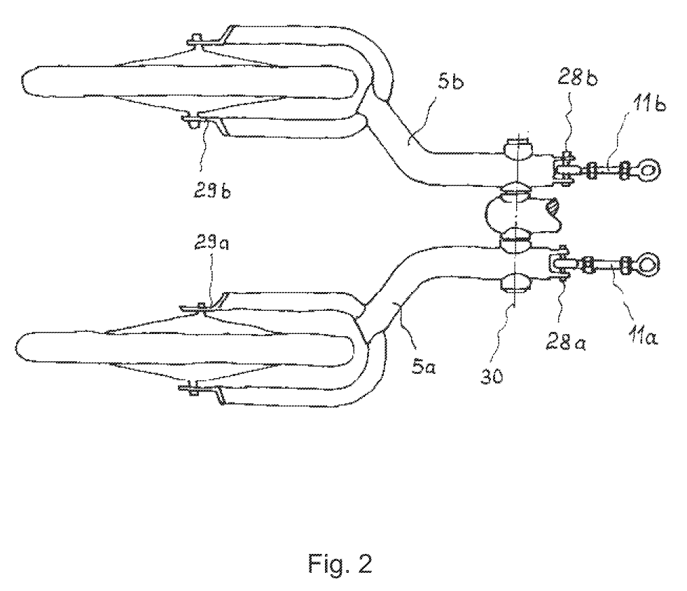

FIG. 3 shows a back view of a tricycle in an inclined position;

FIG. 4 shows a side view of a tricycle with weather protection;

FIG. 5 shows a side view of a tricycle adapted to have tracks and skids;

FIG. 6 shows a side view of a children's tricycle having a pedal crank in the front wheel;

FIG. 7 shows a top view of a children's tricycle having a pedal crank in the front wheel;

FIG. 8 shows a side view of a tricycle with full suspension and an electric drive;

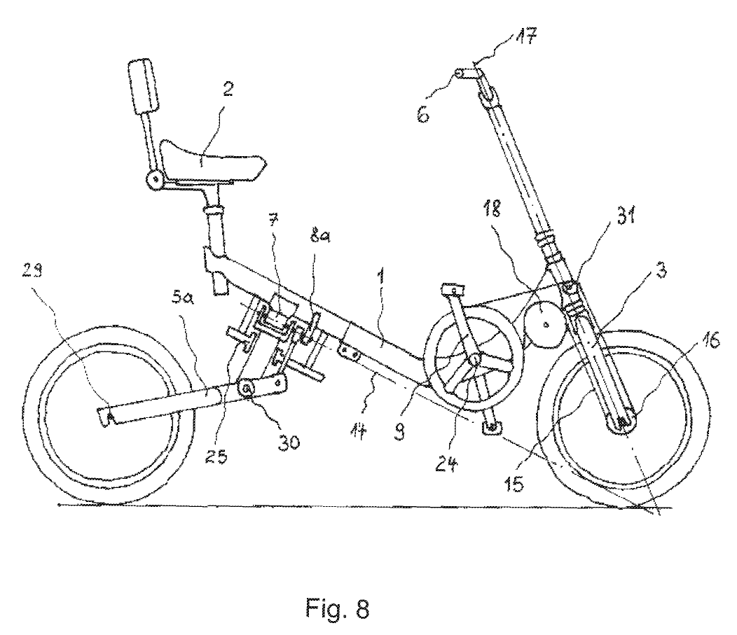

FIG. 9 shows a side view of a tricycle with hydraulic pedal control;

FIG. 10 shows a side view of a tricycle with hydraulic handlebar control;

FIG. 11 shows an isometric side view of a tricycle having a rigid front wheel carrier;

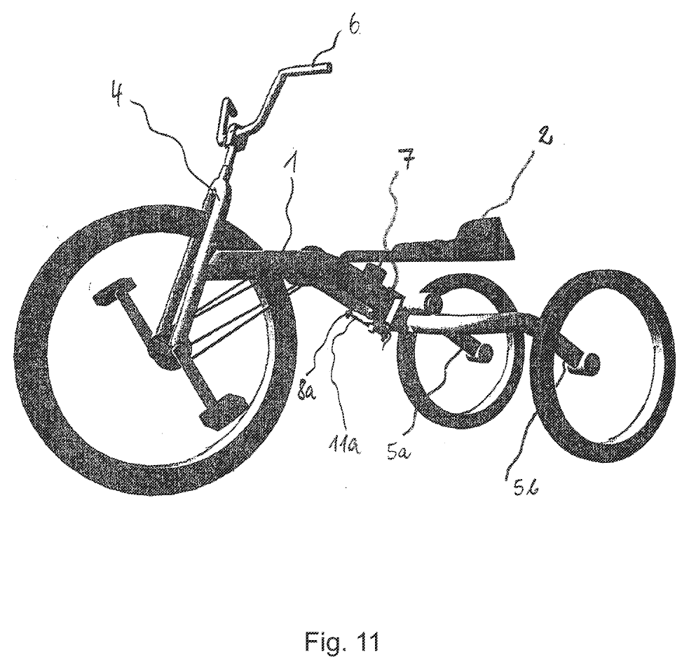

FIG. 12 shows an isometric back view of a tricycle having a rigid front wheel carrier;

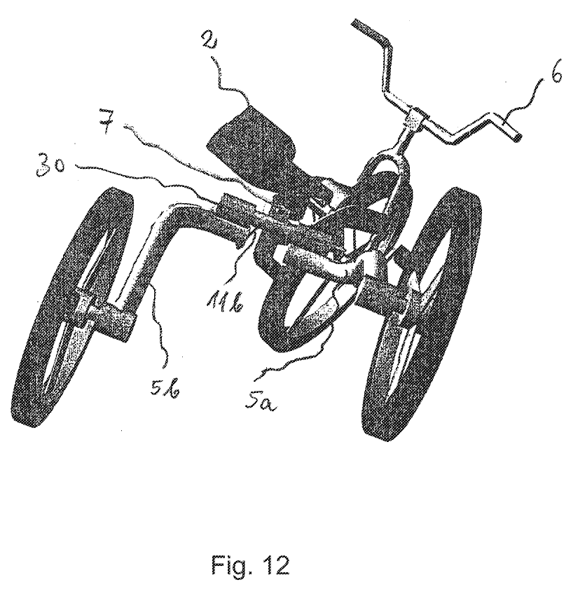

FIG. 13 shows a side view of a tricycle with full casing;

FIG. 14 shows a side view of a tricycle having rigid foot levers;

FIG. 15 shows a side view of a tricycle having foot levers provided with springs;

FIG. 16 shows a side view of a tandem vehicle having a stepper; and,

FIG. 17 shows a side view of a tandem vehicle having a steel cable which may be used as a steering damper.

### DETAILED DESCRIPTION OF THE INVENTION

The tricycle comprises a front wheel and two wheels on rear wheel swing arms 5a, 5b movable in opposite directions, as well as a driver's seat 2 mounted to the vehicle frame 1 and handlebars 6. It may be designed as sports equipment having a rigid front wheel carrier 4 being part of the vehicle frame 1. With a steerable front wheel carrier 3, which may, for example, be implemented as a front wheel fork, it may also be used as a conventional road vehicle, wherein the curve radius and the vehicle inclination may be controlled independent of each other.

The special feature of the new vehicle is that the vehicle frame 1 is rotatably mounted to a steering head 7 beneath the driver's seat 2 and the rear wheels change direction as soon as the vehicle inclines sideways. In addition, driving elements 8a, 8b are arranged in the area of the steering head 7 with control rods 11a, 11b attached thereto, the control rods coupling the rotary movement of the vehicle frame 1 to the opposite movements of the rear wheel swing arms 5a, 5b. The rotation axis 30 of the rear wheel swing arms 5a, 5b is arranged between the receptacles 28a, 28b of the control rods 11a, 11b and the rear wheel mounts 29a, 29b. For this reason, the right rear wheel, for example, will move upward when the right control rod 11a moves downward.

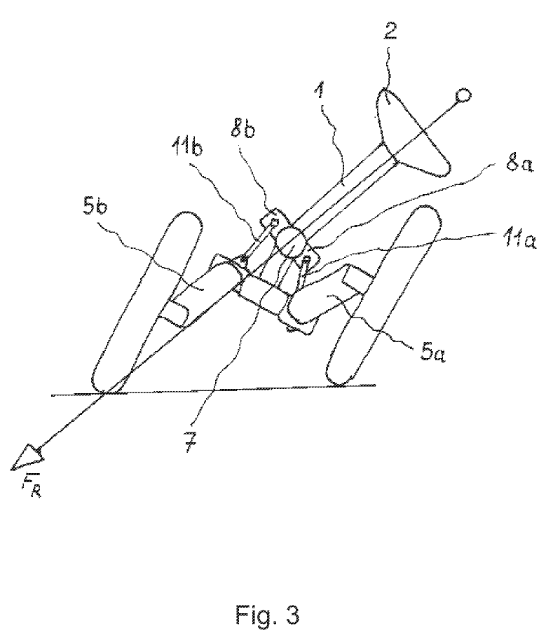

Since the driver's seat 2 is arranged above the steering head 7, it forms a lever together with the vehicle frame 1 which the driver controls by changing the horizontal position of the driver's seat 2 and consequently also the vehicle frame 1 with the help of his or her body weight. As long as this lever is maintained in a position oriented towards the inner side, as shown in FIG. 3, the rigid driving elements 8a, 8b prevent that the rear wheel swing arms 5a, 5b continue to move in opposite directions. Thus the vehicle cannot raise itself from the inclined position, nor can the wheels tilt outwards. As a consequence, the resultant of weight and centrifugal force “FR” runs through the contact point of the outer rear wheel when the velocity in the curve increases. Since the inclination mechanism is designed to have suitable stops so that the vehicle frame 1 with the front wheel cannot be inclined sideways more than 45°, the vehicle will understeer in an extreme case, although the rear wheels are inclined less than the front wheel.

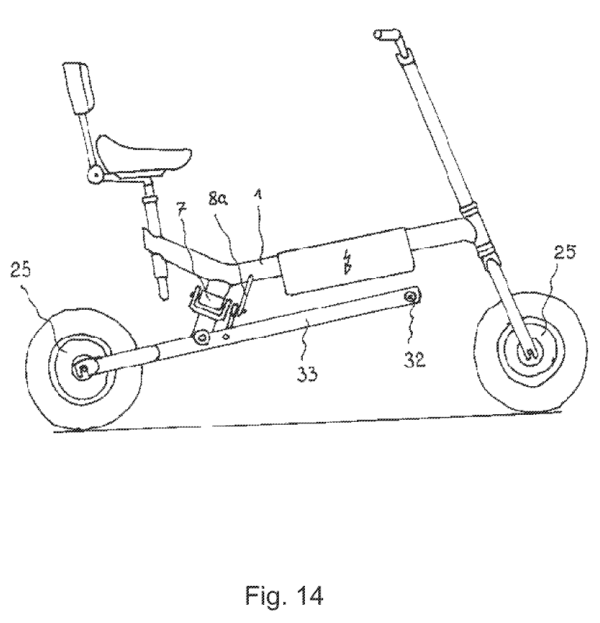

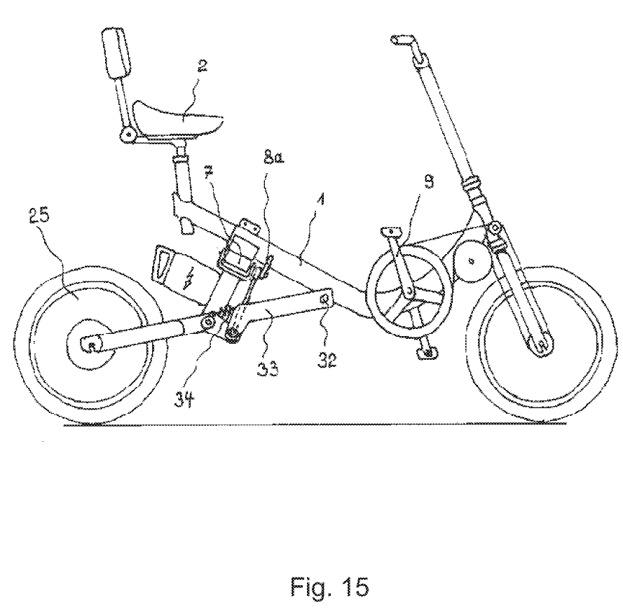

The higher the velocity in the curve, the more force the driver must expend to hold the handlebars 6 and the more he must shift his body inward on the driver's seat 2 to force the vehicle frame 1 in this direction and to prevent the opposite movements of the rear wheel swing arms 5a, 5b. However, he may ultimately only exert a weight force similar to that of a passenger in a sidecar on the vehicle frame 1. To achieve a higher velocity in the curve for fast electric vehicles constructed without pedal cranks 9 or for hybrid vehicles having both pedal cranks 9 and electric hub motors 25, the control of the rear wheel swing arms 5a, 5b may be assisted by mechanical foot levers, as illustrated in FIGS. 14 and 15. For this purpose, the rear wheel swing arms 5a, 5b are extended beyond the receptacles 28a, 28b of the control rods 1 la, 11b by a foot lever 33a, 33b at the end of which there are arranged footrests 32a, 32b. Instead of maintaining the vehicle frame 1 in the desired position with the help of the body weight only, the driver may now also hold on to the handlebars 6 and push the foot lever 33a, 33b powerfully downward on the inner side. As long as the driver maintains the tension between handlebars 2 and footrests 32a, 32b, the rear wheel swing arms 5a, 5b cannot move in opposite directions, even if the driver's body weight is disadvantageously shifted. Depending on the preferred driving style, the foot levers 33a, 33b may also be designed to have a double joint, wherein two gear-wheels intermesh so that their direction of movement is reversed and the driver exerts downward pressure on the outer side. Shock-like loads, such as they occur in uneven terrain, may be absorbed by springs 34a, 34b on the foot levers 33a, 33b. This is particularly useful for sports vehicles where the driver rises from the driver's seat 2 while driving through a curve to be able to exert more pressure on the footrests 32a, 32b.

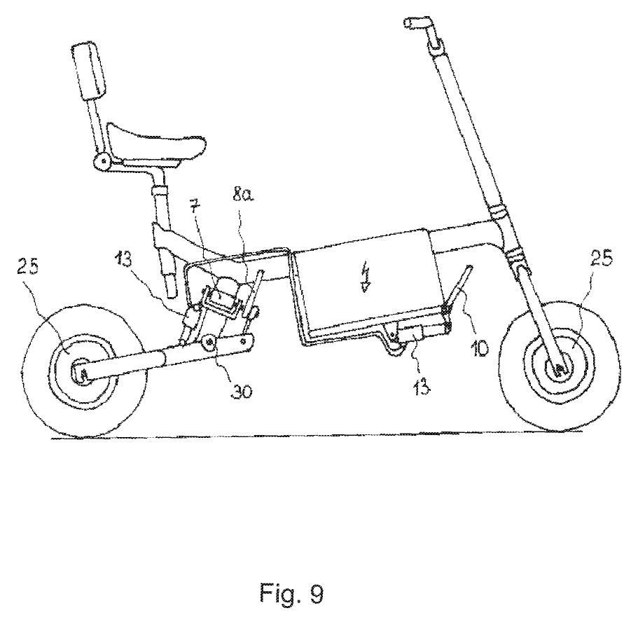

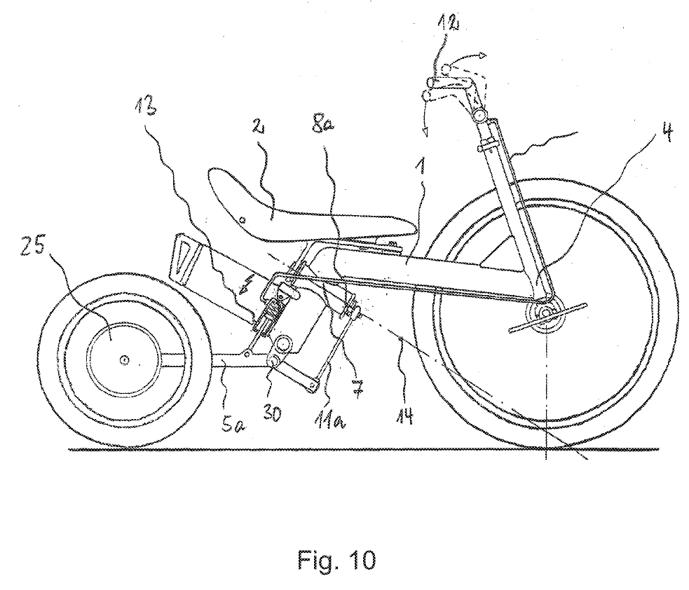

In principle, additional pressure may also be exerted on the rear wheel swing arms 5a, 5b by hydraulic reduction at the foot pedals 10 or the steering levers 12, as shown in FIGS. 9 and 10. This does not necessarily require hydraulic systems, because hydraulic cylinders 13 having different diameters are sufficient in many cases. Electrical actuators are also conceivable instead of hydraulic elements.

With manual chain drive, the new tricycle is suited well for rehabilitation purposes. For balance training, the steering head 7 arranged beneath the driver's seat 2 is blocked by a blocking element 50, which may, for example, be implemented as a hydraulic caliper brake. In the blocked state, the vehicle behaves like a rigid tricycle. After the critical starting phase, when the accelerating vehicle is stabilized by the gyroscopic forces of the wheels, the driver may release the brake lever. Although the initial horizontal position is still supported by the return springs 18, the driving experience during the subsequent straight ride resembles that on a conventional bike.

Vehicles used for sports purposes only, which have a rigid front wheel carrier 4, offer the driver a very dynamic curve behavior, which may be referred to as “swing”, due to the forced control of steering and inclination. The angle between the steering axis 14 of the steering head 7 arranged beneath the driver's seat and the road is preferably 25° to 45°. In vehicles having a steerable front wheel carrier 3, 3° to 25° degrees are sufficient, depending on the achievable maximum speed, because the curve radius may be corrected with the help of the steerable front wheel carrier 3 independent of the vehicle inclination.

Primarily in slower vehicles having a manual chain drive, rear wheel steering is very important, because, in order to save costs, it is necessary to drive the front wheel instead of the two rear wheels. In order to reduce the negative effect that the torque of the drive chain has on the steering, the loaded chain run 15 should be directed from the front wheel hub 16 to a point on the vehicle frame 1 that is as close as possible to the vertical steering axis 17 of the steerable front wheel carrier 3. Since, when steering, the chain and the tire will quickly touch each other, steering is quite restricted in known bicycles with front-wheel drive. In the new tricycle, however, a tight turning circle is achieved by the co-steering of the rear wheels.

The redirection of the chain drive is also very important. In the case of a manual front-wheel drive, the driver normally has to assume a more or less recumbent sitting position to reach the pedals, because the pedal crank bearing is arranged above the front wheel. In order to allow a sitting position on the new tricycle while maintaining sufficient traction of the front wheel and a minimal overturning tendency when braking with the front-wheel brake, an idler pulley 18 is provided on the vehicle frame 1 in the area behind the vertical steering axis 17 of the steerable front wheel carrier 3. With the help of an advantageously arranged chain tensioner 31, the loaded chain run 15 may be directed from the front wheel hub 16 upward to the vehicle frame 1 in parallel to the vertical steering axis 17 of the steerable front wheel carrier 3 and from there downward to the chain wheel of the pedal crank 9 in a low, ergonomically advantageous position and back again without significant load effects on the steering.

For the vehicle to automatically assume an initial horizontal position, return springs 18a, 18b may be arranged between the steering head 7 arranged beneath the driver's seat 2 and the rear wheel swing arms 5a, 5b. They exert the same amount of pressure on both rear wheel swing arms 5a, 5b and tend to force them into a balanced position. The same is achieved if a torsion spring or a torsion bar is integrated in the steering head 7.

The spring mechanism for the rear wheel swing arms 5a, 5b movable in opposite directions may be realized by a central strut 19. For this purpose, the steering head 7 is also movably mounted to a swivel joint 20 arranged in a transverse direction relative to the direction of travel, and is connected to the central strut 19, which may, for example, be equipped with a tension spring.

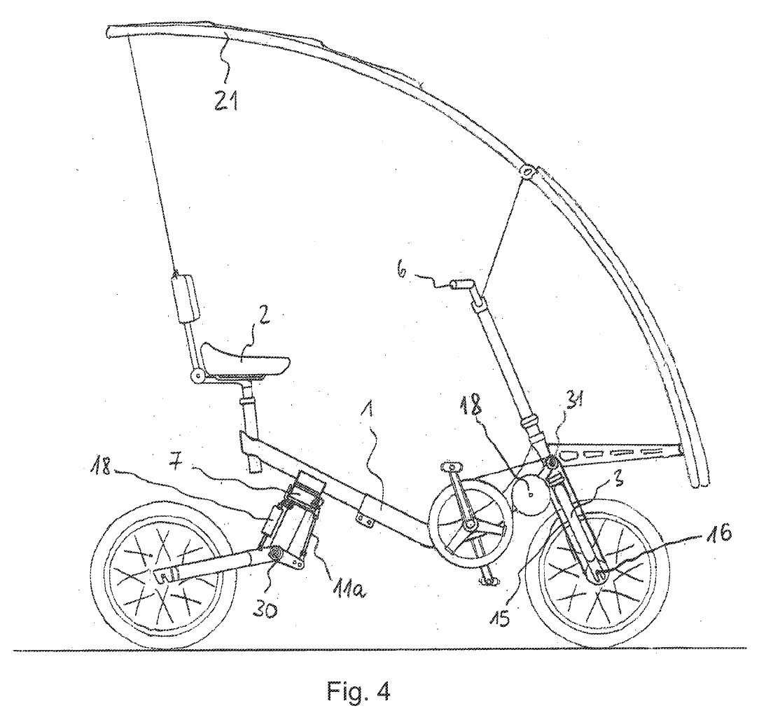

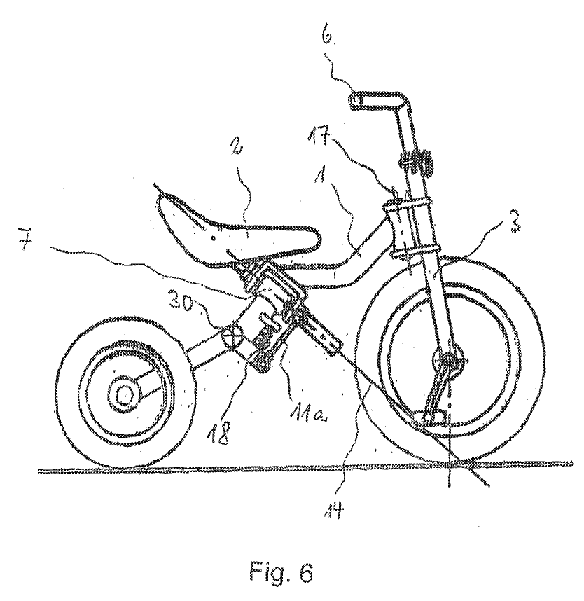

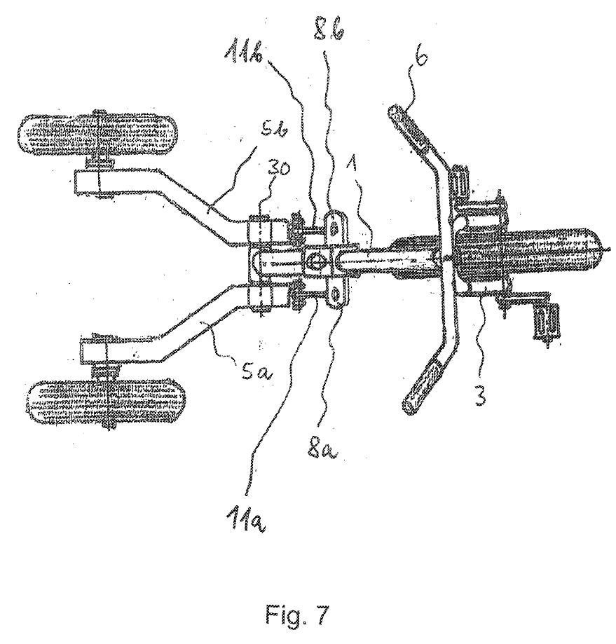

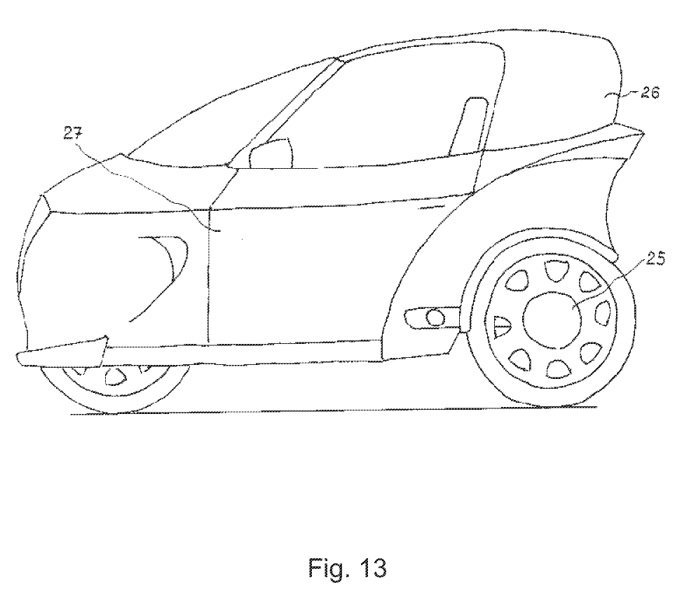

Due to the simple mechanical control of the inclination mechanism, even children's vehicles may be provided therewith, as illustrated in FIGS. 6 and 7. Similarly, city vehicles driven by electric hub motors 25 and provided with a weather protection element 21, as illustrated in FIG. 4, or vehicles completely enclosed by a hardtop 26 and a lateral sliding door 27, as illustrated in FIG. 13, may, for example, be provided therewith. Such vehicles may even be provided with an additional seat arranged behind or in front of the driver's seat.

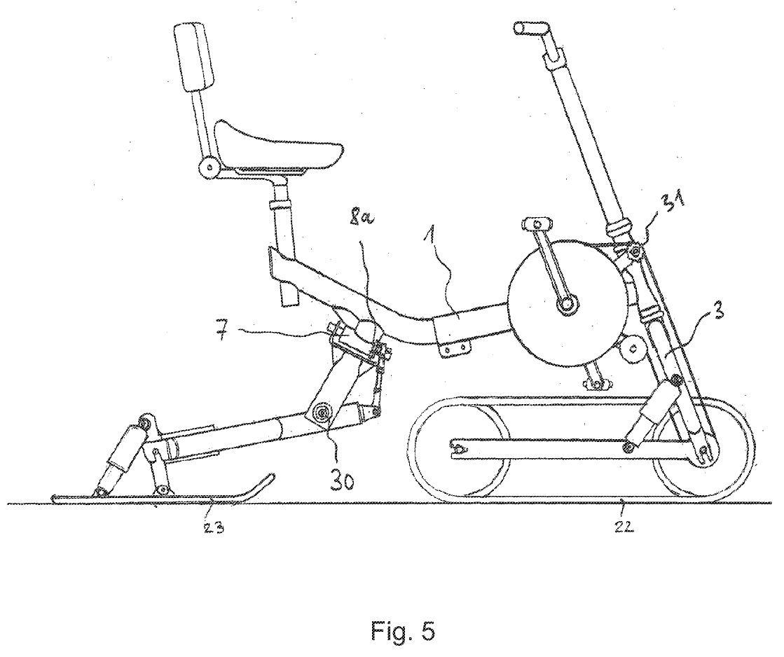

The presented tricycle may also be used for winter sports, if the wheels are replaced by snow tracks 22 or skids 23, as illustrated in FIG. 5.

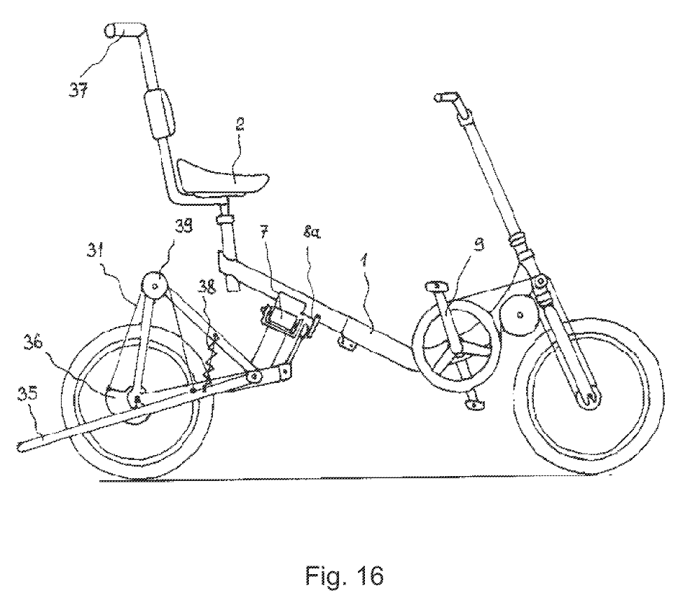

In addition, tandem vehicles usable for sports purposes are conceivable, wherein the passenger holds on to a bar 37 mounted to the driver's seat 2 and drives the rear wheels by means of a stepper, as shown in FIG. 16. In this case, footboards 35a, 35b provided with return springs 38a, 38b are movably mounted to the outer or inner side of each rear wheel swing arm 5a, 5b, wherein the passenger pushes the left and right footboards alternately downward with his feet. As a consequence, a spiral-shaped chain wheel 36a, 36b, which is provided with a freewheel mechanism and flanged to the hub of one of the two rear wheels, is rotated via a chain hoist 31a, 31b with an idler pulley 39a, 39b. After the respective footboard 35a, 35b has been pulled into the initial position by the return spring 38a, 38b, the spiral-shaped chain wheel 36a, 36b, too, is again in the initial position. In this way, the passenger may drive the rear wheels with the stepper, while the driver drives the front wheel with the pedal crank 9.

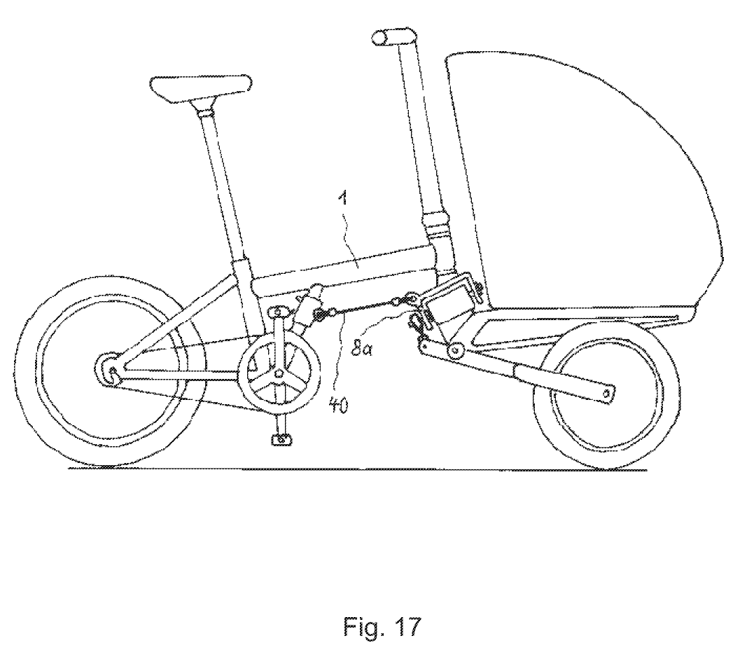

In principle, the inclination joint may also be used in the front portion, as shown in FIG. 17, wherein a steel cable 40 may be used as a steering damper.

What is claimed is:

1. A three-wheeled vehicle comprising:
a vehicle frame;
a driver's seat and two rear wheel swing arms movable in opposite directions;
a steering head having rigid driving elements, the steering head arranged on the vehicle frame in the area of the driver's seat; and
control elements to control the vehicle inclination and steer the rear wheels, wherein the steering head couples the inclination of the vehicle frame to the opposite movements of the rear wheel swing arms by utilizing the control elements.

2. The three-wheeled vehicle as defined in claim 1, wherein a rotation axis of the rear wheel swing arms is arranged between receptacles of the control rods and rear wheel mounts so that lateral inclination of the vehicle frame results in an upward movement of the inner rear wheel.

3 . The three-wheeled vehicle as defined in claim 2, wherein the rear wheel swing arms are extended from the rotation axis beyond the receptacles of the control rods by a foot lever to receive footrests which assist in the control of the upward and downward movements of the rear wheel swing arms.

4. The three-wheeled vehicle as defined in claim 1, further comprising an idler pulley is arranged on the vehicle frame in the area behind a vertical steering axis of a steerable front wheel carrier, the idler pulley designed to redirect a chain drive of a manually driven front wheel backwards relative to the direction of travel to obtain a low position of a pedal crank bearing.

5. The three-wheeled vehicle as defined in claim 1, further comprising footboards with return springs arranged on the rear wheel swing arms, the footboards utilizing chain hoists and spiral-shaped chain wheels to drive the rear wheels.

6. The three-wheeled vehicle as defined in claim 5, wherein the return springs are arranged at the steering head beneath the driver's seat, the return springs stabilizing the horizontal position of the vehicle by forcing the rear wheel swing arms into a balanced mid-position.

7. The three-wheeled vehicle as defined in claim 1, further comprising a central strut articulated between the steering head arranged beneath the driver's seat and the vehicle frame.

8. The three-wheeled vehicle as defined in claim 1, further comprising hydraulic cylinders provided at the steering head arranged beneath the driver's seat, the hydraulic cylinders allowing additional control of the opposite movements of the rear wheel swing arms.

9. The three-wheeled vehicle as defined in claim 1, further comprising a blocking element provided at the steering head arranged beneath the driver's seat, the blocking element blocking the rotary movement of the steering head.

10. The three-wheeled vehicle as defined in claim 1, further comprising receiving bores provided on the rear wheel swing arms movable in opposite directions and on the front wheel carrier, the receiving bores receiving mounted snow tracks or skids.

11. The three-wheeled vehicle as defined in claim 1, further comprising a roof-like weather protection element is arranged on the vehicle frame.
